(19) United States
(12) Patent Application Publication
(10) Pub. No.: US 2007/0083318 A1
(43) Pub. Date: Apr. 12, 2007

(54) Adaptive cruise control using vehicle-to-vehicle wireless communication

(76) Inventor: Jayendra S. Parikh, Bloomfield Hills, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/245,968

(22) Filed: Oct. 7, 2005

(51) Int. Cl. B60T 8/32

(52) U.S. Cl. 701/96; 701/93; 180/170

(57) ABSTRACT

A method and system to control forward movement of a vehicle having adaptive control system and a localized communications system, including establishing communications with a target vehicle, identifying the target vehicle to the operator, verifying operator intent, and, executing an automatic following routine. The automatic following routine operates based upon operating parameters of the target vehicle and host vehicle, and, predetermined parameters for following. The operating parameters include vehicle heading, speed, acceleration, operator input to a brake pedal, and, difference in acceleration between the host vehicle and the target vehicle. Disengaging the automatic following routine occurs when one of the target vehicle operating parameters changes by a predetermined amount, e.g., based upon a braking event, interference from third vehicle, operator input, when the target vehicle exceeds a predetermined speed, upon interruption of communications between the host vehicle and the target vehicle, or, upon operator command.

### INCORPORATION BY REFERENCE

Applicant incorporates by reference U.S. Pat. No. 6,622,810 B2, entitled ADAPTIVE CRUISE CONTROL SYSTEM, in that an exemplary method and apparatus for adaptive cruise control need not be fully described in detail herein.

### TECHNICAL FIELD

This invention pertains generally to vehicle operation control, and more specifically to adaptive control for use in vehicles equipped with short-range wireless communication systems.

### BACKGROUND OF THE INVENTION

Adaptive vehicle cruise control systems have been developed for maintaining the speed of a controlled, or host vehicle at an operator-selected speed. In conjunction with these known cruise systems, an adaptive cruise control system has been developed for detecting the presence of, and the distance to, a leading, or target vehicle, and for adjusting vehicle speed to maintain a following distance from the target vehicle when it is moving slower than the operator-selected speed. In essence, speed of the host vehicle is controlled to the speed of the target vehicle with a speed-dependent separation being maintained from the target vehicle, wherein the speed of the host vehicle is limited at an operator-selected speed.

Adaptive cruise control systems typically have conventional cruise control that may be overridden in certain circumstances by an adaptive vehicle speed control routine. The conventional cruise control, when activated, may include a control function designed to minimize a difference between the actual vehicle speed and a cruise-set speed, which is selected by the operator. The adaptive cruise control system further adapts control based upon the external environment by detecting and accounting for intervening vehicles.

One form of adaptive control lies in the reduction of the cruise-set speed below the operator-selected speed by an amount determined and periodically updated to provide controlled following of sensed preceding vehicles traveling slower than the operator-selected speed. A speed command is generated, based in part on the speed relationship between the source vehicle and the preceding vehicle. The cruise set speed is limited accordingly, to adapt the source vehicle speed to that of the preceding vehicle and provide a controlled following relationship.

It is well known to provide automatic vehicle cruise control systems for maintaining the speed of a vehicle at an operator-set speed. It is further known to provide, in conjunction with these known cruise systems, a system for detecting the presence and the distance to a preceding vehicle and for adjusting the vehicle speed to maintain a trailing distance to the preceding vehicle. In essence, the vehicle speed is controlled to the speed of the preceding vehicle with a predetermined separation from the preceding vehicle with the vehicle speed being limited at the operator-set cruise speed. Typically, the trailing distance provided by these known systems is a predetermined calibrated value or schedule of values as a function of parameters such as vehicle speed. These calibration values generally do not take into account varying traffic conditions, weather conditions, road surface conditions or personal driving habits of the vehicle operator. The calibrated values are accordingly a compromise that may be optimum for one operator and for a specific set of weather/road/traffic conditions but may not be optimum for different operators and varying conditions.

Another example of an adaptive cruise control system provides a speed dependent following distance adjustable by the vehicle operator. This adjustment affects a speed multiplier term used in the determination of the speed dependent following distance. For a fixed speed multiplier, the desired following distance typically increases with increasing vehicle speed. An exemplary adaptive cruise system for a vehicle maintains a desired selected operator-set speed in the absence of a detected preceding target vehicle and adjusts the vehicle speed when the target vehicle is detected to maintain a following distance that is set by the vehicle operator. An alert distance is computed that is a predetermined function of a distance based on operator reaction time. To provide for the operator-selectable trailing distance, the operator reaction term of the alert distance is adjusted by the vehicle operator to achieve a desired distance to the target vehicle. The aforementioned adaptive cruise control systems typically utilize radar systems operating in the range of 76 GHz radio frequency band to identify the target vehicle. Such radar systems and accompanying hardware and software algorithms include costly hardware that requires significant investment of engineering resources to implement and calibrate.

Practitioners are developing and implementing on-vehicle short to medium range communications systems, including those referred to as Dedicated Short Range Communications (‘DSRC’). Such systems provide standardized communications protocols for use in communicating between vehicles, and for use in broadcast communications. A DSRC complements cellular communications by providing very high data transfer rates in circumstances wherein minimizing latency in the communication link and isolating relatively small communication zones are important. A typical system includes an on-vehicle transceiver providing communications, a controller, and a vehicle operator interface. Such systems may be used to facilitate management of road systems to reduce congestion, and provide logistical support to fleet managers.

Therefore, it is advantageous to a vehicle operator to have a vehicle equipped with a short to medium range communications system and an adaptive cruise control system to communicate with other vehicles on the road in an ad hoc communication network, to better control forward motion of the vehicle during specific conditions defined by vehicle operating conditions, and traffic and road conditions.

### SUMMARY OF THE INVENTION

It is therefore an object of this invention to provide a method and system to control forward movement of a host vehicle, the host vehicle having an adaptive control system operable to control forward movement and a localized communications system. The method and system comprise establishing communications with a target vehicle, identifying the target vehicle to an operator of the host vehicle, verifying operator intent to follow the target vehicle, and executing an automatic following routine.

An aspect of the invention comprises executing the automatic following routine based upon target vehicle operating parameters and host vehicle operating parameters, and predetermined parameters for following.

Another aspect of the invention comprises the target vehicle operating parameters including target vehicle heading, speed, acceleration, and operator input to a brake pedal.

Another aspect of the invention comprises the predetermined parameters for following including target vehicle forward speed and acceleration, and a difference in acceleration between the host vehicle and the target vehicle.

Another aspect of the invention comprises disengaging the automatic following routine when at least one of the target vehicle operating parameters changes by a predetermined amount, e.g., based upon a braking event, interference from an intervening object, operator input, when the target vehicle exceeds a predetermined speed, upon interruption of communications between the host vehicle and the target vehicle or upon an operator input.

Another aspect of the invention comprises establishing communications with the target vehicle using a dedicated short-range communication system.

Another aspect of the invention comprises identifying the target vehicle to the operator of the host vehicle by communicating vehicle attribute data with an in-vehicle communications center.

Another aspect of the invention comprises executing the automatic following routine by verifying the communications link with the target vehicle, communicating with the target vehicle to determine target vehicle operating parameters, verifying the target vehicle operating parameters are each within predetermined range and determining output signals to control forward speed and acceleration of the host vehicle based upon the target vehicle operating parameters.

Another aspect of the invention comprises controlling output signals to control forward speed and acceleration of the host vehicle based upon the target vehicle operating parameters including controlling engine throttle position and braking.

In accordance with another aspect of the invention, braking may comprise wheel braking or engine braking.

Another aspect of the invention comprises determining output signals to control forward speed and acceleration of the host vehicle based upon the target vehicle operating parameters, including controlling magnitude of electrical energy delivered to a wheel motor, or, controlling magnitude of electrical energy delivered to an electric motor propulsion system.

These and other aspects of the invention will become apparent to those skilled in the art upon reading and understanding the following detailed description of the embodiments.

### BRIEF DESCRIPTION OF THE DRAWINGS

The invention may take physical form in certain parts and arrangement of parts, the preferred embodiment of which will be described in detail and illustrated in the accompanying drawings which form a part hereof, and wherein:

FIG. 1 is a schematic diagram of an adaptive cruise system, in accordance with the present invention;

FIG. 2 is a schematic diagram of an alternate embodiment of adaptive cruise system, in accordance with the present invention; and,

FIG. 3 is an algorithmic flowchart, in accordance with the present invention.

### DETAILED DESCRIPTION OF EMBODIMENTS OF THE INVENTION

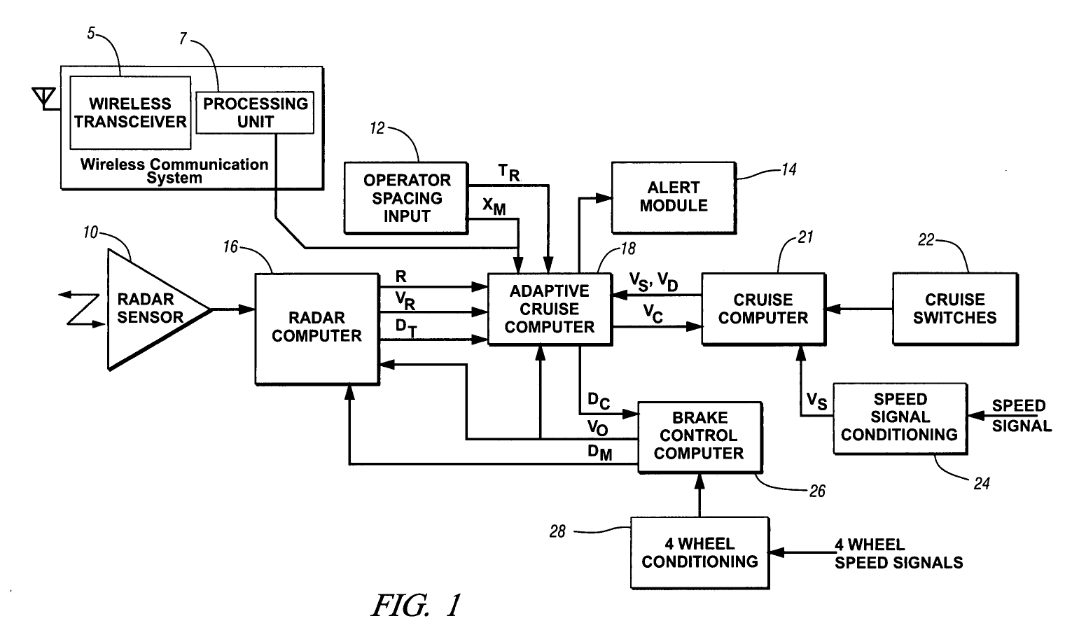

Referring now to the drawings, wherein the showings are for the purpose of illustrating the invention only and not for the purpose of limiting the same, FIG. 1 shows a schematic of a first embodiment of an adaptive cruise control (‘ACC’) system which has been constructed in accordance with an embodiment of the present invention. The adaptive cruise control system employed in the first embodiment has been previously described in U.S. Pat. No. 6,622,810 B2, entitled ADAPTIVE CRUISE CONTROL SYSTEM, incorporated by reference hereinabove, in that an exemplary method and apparatus for adaptive cruise control need not be fully described in detail herein.

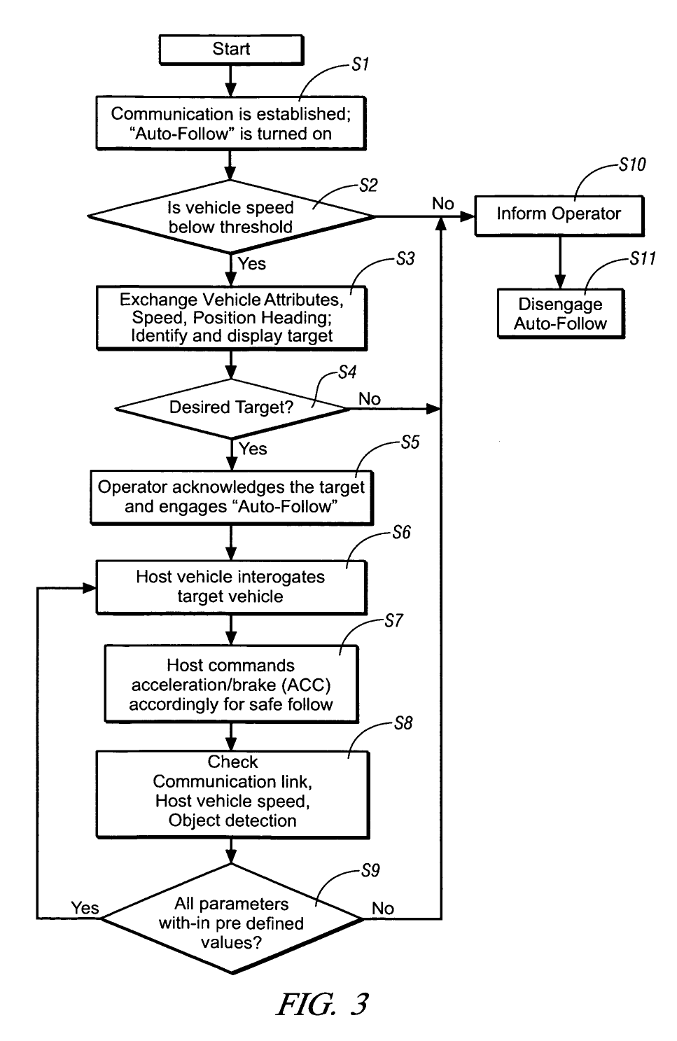

The exemplary system includes a wireless communications transceiver 5 and controller 7 providing a signal output that is input to an adaptive cruise computer 18 modified to accept and process such signal input. The wireless communications transceiver 5 and controller 7 are preferably adapted to execute a conventional standardized communications protocol, such as a dedicated short-range communications (‘DSRC’) protocol, which is known to a skilled practitioner. The wireless communications system includes a global positioning system (‘GPS’) receiver for determining host vehicle position and heading. The adaptive cruise computer 18 preferably includes control algorithms, including an algorithm comprising an automatic following routine, to determine a vehicle speed, Vs. The automatic following routine is described in detail hereinbelow with reference to FIG. 3.

The system includes a conventional cruise computer 21 which operates in response to conventional operator-controlled switches, such as an on/off switch, a set switch, a resume/accelerate switch, and a brake switch, all of which are represented in the aggregate as cruise switches 22. Speed signal conditioning circuit 24 supplies cruise computer 21 with vehicle forward speed V_{S} derived from a conditioned raw speed signal indicative of succeeding vehicle speed. The raw speed signal may, for example, be from a conventional rotational speed transducer arrangement such as a variable reluctance sensor cooperating with a toothed gear rotating with the output shaft of the vehicle transmission.

Cruise computer 21 also receives a speed command V_{C} from the adaptive cruise computer 18. The cruise computer uses the speed command V_{C} and vehicle speed V_{S} a conventional closed loop control of the vehicle speed through control of engine throttle (not shown). Cruise computer 21 also provides to adaptive cruise computer 18 the vehicle speed V_{S} and desired operator set speed V_{D}.

Adaptive cruise computer 18 also interfaces with a brake control computer 26 and radar computer 16 as illustrated. Preferably, additional operator interfacing is accomplished by way of a modified operator spacing input 12 and alert module 14 as later described. Brake control computer 26 receives a deceleration command Dc from adaptive cruise computer 18 and provides a measure of vehicle speed V_{O} derived from wheel speed sensing to the adaptive cruise computer 18. The wheel speed sensing is accomplished by way of a four wheel speed signal conditioning circuit 28 operating upon four individual, raw wheel speed signals, one for each of four wheels of the vehicle. The raw wheel speed signals may be provided for example by way of well known variable reluctance wheel speed sensors. All four conditioned signals are provided as input to the brake control computer 26 and may be used thereby in performing traction applications such as anti-lock braking, traction control, and may include advanced features such as active braking and vehicle yaw control. The vehicle speed V_{O} provided to adaptive cruise control computer 18 is derived from the four discrete wheel speed signals as a predetermined function. The brake control computer 26 additionally provides the vehicle speed V_{O} and a measured deceleration D_{M} of the succeeding vehicle—also derived as a predetermined function of the four discrete wheel speed signals—to the radar computer 16. An exemplary brake control computer providing ABS and traction control functions, and suitable for application to the present invention, is commercially available. Also, an exemplary brake control computer providing additional advanced control functions including active brake control and vehicle yaw control, and suitable for application to the present invention, is commercially available.

A known short-range forward looking radar sensor 10 communicating with radar computer 16 provides to the adaptive cruise computer 18 a variety of signals related to an in-path preceding vehicle. Radar sensor 10 preferably comprises a low-cost radar sensor operating in the range of 24 GHz, and provides output signals to radar computer 16 which derives the distance or range R between the succeeding and preceding vehicles, the closing or relative velocity V_{R} between the preceding and succeeding vehicles (also known as the range rate), and the preceding vehicle deceleration DT. Preceding vehicle deceleration is provided as a function of the relative deceleration between the succeeding and preceding vehicles, which is derived in the radar computer 16 from the range R and range rate V_{R}, and the measured deceleration D_{M} of the succeeding vehicle supplied by the brake control computer.

In this embodiment of the invention, operator interface with the adaptive cruise computer 18 is accomplished by way of the modified operator spacing input 12 and alert module 14. The alert module 14 is preferably modified to provide sufficient information for the operator to identify a target vehicle for automatic following, which is described in detail hereinbelow. Target vehicle operating parameters preferably include vehicle attributes comprising make, model, and color of the vehicle, target vehicle heading, speed, and acceleration, and location of the target vehicle relative to the host vehicle. The target vehicle operating parameters are determined by communications between the host and target vehicles effected by the wireless transceiver 5 of the wireless communications system. The modified operator spacing input 12 is preferably operable to permit the operator engage the automatic following routine. The modified operator spacing input 12 may take the form of a detented or continuously variable potentiometer whose operator-controlled setting corresponds to a desired minimum inter-vehicle spacing X_{M} and operator reaction time T_{R}. The modified alert module 14 may take the exemplary form of a vehicle instrument cluster or other display panel visual and/or audible alerting apparatus for conveying predetermined adaptive cruise control system information, including target vehicle attributes, to the vehicle operator. The cruise computer 21, adaptive cruise computer 18, radar computer 16 and brake control computer 26 are general purpose digital computers generally including a microprocessor, ROM, RAM, and I/O including A/D and D/A. Each respective computer has a set of resident program instructions stored in ROM and executed to provide the respective functions of each computer. The information transfer between the various computers, while schematically illustrated in FIG. 1 as individual data lines, is preferably accomplished by way of serial data links in this embodiment.

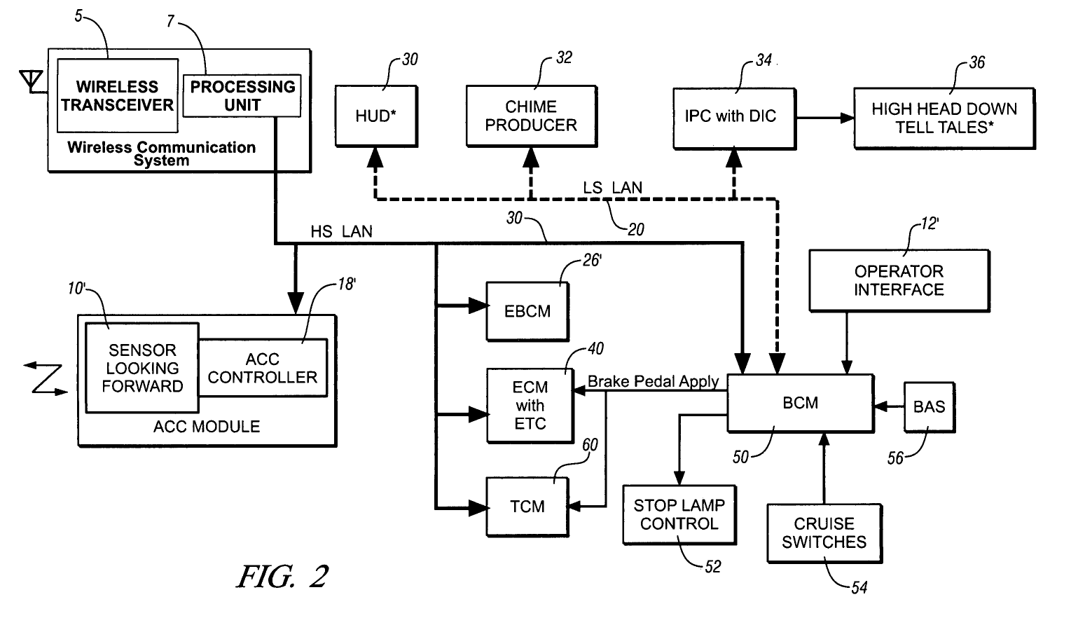

Referring now to FIG. 2, a second embodiment of the invention is described in detail. In this embodiment, the vehicle system comprises a distributed controller system having a plurality of controllers signally connected via local area networks (‘LAN’). The exemplary system includes the wireless communications transceiver 5 and controller 7 providing signal output that is connected to a high speed LAN bus 30, which is readable by an adaptive cruise computer 18 modified to accept such signal input, as well as other devices communicating on the high speed LAN bus 30, including a body control module (BCM) 50, an electronic brake control module (EBCM) 26′, including anti-lock brake functionality, an engine control module (ECM) 40, and, transmission control module (TCM) 60. As previously described, the wireless communications transceiver 5 and controller 7 with GPS receiver are preferably adapted to execute conventional standardized communications protocol, such as the dedicated short-range communications (‘DSRC’) protocol. Each of the aforementioned modules and controllers are preferably general purpose digital computers generally including a microprocessor, ROM, RAM, and I/O including A/D and D/A. Each respective computer has a set of resident program instructions stored in ROM and executed to provide the respective functions of each computer. Information transfer between the various computers is preferably accomplished by way of a high-speed LAN bus 30 in this embodiment, as previously mentioned.

The exemplary ACC module preferably comprises a forward-looking sensor (FLS) 10′, preferably a 24 GHz radio frequency radar sensor, and the ACC controller 18′. This module preferably senses and processes objects found in the road environment and acts as the overall executive implementing various functions of the ACC subsystem. The Forward Looking Sensor provides data concerning proximate vehicles, including the target vehicle, to the ACC controller 18′. The ACC controller preferably processes control signals from cruise control switches 54 and from the DSRC transceiver 5, received via the high speed LAN 30. The ACC controller 18′ engages and disengages adaptive cruise control and determines the operator-selected speed, and executes the automatic follower routine, as described hereinbelow. The ACC controller sends commands to the ECM 40 and EBCM 26′ to control vehicle acceleration/deceleration based on input from the Forward Looking Sensor and the DSRC sensor, when activated by the operator. The ACC controller 18′ is preferably responsible for controlling and prioritizing all status information and displays relative to the automatic following routine and other ACC functions, including, for example, forward collision alert functions. The ACC module is typically further responsible to assure that displayed vehicle speed and displayed operator-selected speed match when ACC is active and controlling to the operator-selected speed.

The Engine Control Module (ECM) 40 is operable to control various aspects of a vehicle powertrain, and contains functions directly related to ACC, including electronic throttle control. The ECM 40 controls vehicle acceleration and deceleration requested by the ACC controller 18′ while ACC is active, provided automatic braking is not active. The ECM is operable to release throttle control commanded by the ACC controller 18′ whenever either ACC is not active or automatic braking is active. The ACC controller 18′ indicates to the ECM when ACC is active and the EBCM 26′ indicates when automatic braking is active. The ECM is responsible for determining when the operator is pressing the vehicle accelerator pedal and overriding the ACC requested acceleration/deceleration.

The EBCM 26′ preferably comprises a chassis controller operable to provide anti-lock braking control, traction control, variable effort steering, and vehicle dynamics control. The BCM preferably acts to decelerate the vehicle by applying brake pressure to all four wheels when ACC so commands, or is transitioning out of the active state. A brake apply switch (‘BAS’) 56 provides input to the BCM 50 comprising operator demand for braking, and typically comprises a brake pedal pressure sensor. The EBCM preferably provides vehicle braking on all four wheels using a four channel Brake Pressure Modulator Valve (BPMV) when automatic braking is requested by the ACC controller, and releases vehicle braking when an operator throttle override signal is active. The EBCM preferably provides information to the ACC controller 18′, via the high speed LAN 30, including actual vehicle acceleration, activation status of features including traction control and vehicle dynamics control, wheel speed status and wheel rotational status. Other EBCM functions include indicating on the high speed LAN 30 whether the EBCM module is capable of providing automatic braking; indicating when automatic braking function is active, including when brake lights are to be illuminated and determining operator-applied brake pressure from BAS 56.

The transmission control module (TCM) 60 is a module which preferably provides gear shifter position information to the ACC controller 18. This information is typically used by the ACC controller 18 in ACC engage/disengage checks.

Alternatively, when the host vehicle includes a propulsion system having some form of electric power providing motive force to vehicle wheels, the output signals to control host vehicle forward speed and acceleration based upon the operating parameters can comprise controlling magnitude of electrical energy delivered to a wheel motor, or other systems which control magnitude of electrical energy delivered to the electric motor propulsion system. Such propulsion systems include various forms of electric vehicles and hybrid vehicles.

The body control module (BCM) 50 is preferably operable to read and process information from cruise control switches 54 and information from the ACC enable switch 12′, including auto-follow information. The BCM preferably performs other functions, including operating a brake-apply sensing system and activating brake lamps 52.

The ACC enable switch 12′ is preferably some form of control device useable by the operator to select a target vehicle for the automatic following routine, and to adjust operator-selected headway or following distance.

The vehicle is preferably equipped with a means to provide ACC telltales 36, including for example, indicator lamps showing the ACC as active or inactive, showing the target vehicle, and showing any alerts. The ACC telltales 36 are preferably located either in a head up display 30, or in a module mounted on an instrument panel 34 of the vehicle or on an instrument cluster. Telltales are typically controlled by the instrument panel 34 based on commands received from the ACC controller 18.

The instrument panel 34 preferably includes an operator information center, also referred to as a Driver Information Center (‘DIC’), which provides visual, audible, and tactile (i.e. pushbutton) interface between the vehicle and the operator. It is preferably connected via a low speed LAN 20 to the BCM 50. It is operable to provide an audible signal via a chime 32, or voice-recognition system (not shown). Further functions of the instrument panel 34 include sending messages to the operator regarding system operation and functionality.

Referring now to FIG. 3, flowchart detailing the automatic follower routine is described in detail. When the automatic follower routine, referred to as “Auto-Follow”, is activated by the operator in the host vehicle, this indicates the operator is interested in engaging in automatic following of the target vehicle. The wireless communications transceiver 5 and controller 7 of the host vehicle establishes communications with one or more target vehicles S1. An ad hoc communication network may be established engaging several surrounding vehicles. It is determined whether host vehicle speed is less than a threshold value, in this example being at or about 40 km/hour (25 mph) S2. Other conditions, e.g. host vehicle operating conditions, road surface conditions, or ambient conditions of rain, hail, sleet, snow, ice, and sunlight, may be used by the automatic follower routine in deciding whether to engage the automatic follower routine, either separately, or in combination with vehicle speed. When the conditions are not met, e.g., vehicle speed exceeds the threshold value, the operator is informed S10, and the automatic follower routine is disengaged S11. When the conditions are met, e.g. vehicle speed is less than the threshold value, the wireless communications transceiver 5 and controller 7 exchanges vehicle attributes with the target vehicle(s), and identifies and displays the attributes to the operator using the Driver Information Center S3. The operator identifies the target vehicle as a desired target S4, and acknowledges and engages the automatic follower routine using the switch S5. When the automatic follower routine is engaged, the host vehicle enters a routine wherein it interrogates the target vehicle for attribute data, thus identifying the vehicle, and determining target vehicle operating parameters S6. The target vehicle operating parameters, including, e.g., target vehicle position, heading, speed, acceleration and braking, are communicated to the ACC controller 18 18′. The ACC controller is operable to command acceleration and braking of the host vehicle for safe following, based upon the target vehicle operating parameters S7. The wireless communications transceiver 5 and controller 7 check or verify the communication link with the target vehicle, the host vehicle operating conditions, and presence of any intervening objects, e.g. another vehicle cutting in between the host vehicle and the target vehicle S8. As long as the aforementioned information continues to be valid, or within predetermined limits, the automatic follower routine continues operating S9. When the aforementioned information becomes invalid, or falls outside the predetermined limits, the operator is informed S10, and the automatic follower routine is disengaged S11.

The invention has been described with specific reference to the preferred embodiments and modifications thereto. Further modifications and alterations may occur to others upon reading and understanding the specification. It is intended to include all such modifications and alterations insofar as they come within the scope of the invention.

Having thus described the invention, it is claimed:

1. Method for controlling forward movement of a host vehicle, the host vehicle having an adaptive control system operable to control forward movement and a localized communications system, comprising:
a) establishing communications with a target vehicle;
b) identifying the target vehicle to an operator of the host vehicle;
c) verifying an intent by the operator to follow the target vehicle; and,
d) executing an automatic following routine.

2. The method of claim 1, wherein executing the automatic following routine further comprises executing the automatic following routine based upon: target vehicle operating parameters, host vehicle operating parameters, and, predetermined parameters for following.

3. The method of claim 2, wherein the predetermined parameters for following comprise host vehicle forward speed and acceleration, and a difference in acceleration between the host vehicle and the target vehicle.

4. The method of claim 2, wherein the target vehicle operating parameters comprise: target vehicle heading, speed, acceleration, and brake pedal input.

5. The method of claim 4, further comprising: disengaging the automatic following routine when at least one of the target vehicle operating parameters changes by a predetermined amount.

6. The method of claim 5, further comprising: disengaging the automatic following routine based upon a target vehicle braking event.

7. The method of claim 5, further comprising: disengaging the automatic following routine based upon detection of an intervening object.

8. The method of claim 5, further comprising: disengaging the automatic following routine based upon an operator input.

9. The method of claim 5, further comprising disengaging the automatic following routine when the target vehicle speed exceeds a predetermined speed.

10. The method of claim 5, further comprising disengaging the automatic following routine when the target vehicle acceleration exceeds a predetermined acceleration.

11. The method of claim 1, wherein establishing communications with a target vehicle comprises communicating with the target vehicle using a dedicated short-range communications system.

12. The method of claim 1, wherein identifying the target vehicle to an operator of the host vehicle comprises communicating vehicle attribute data with an in-vehicle communications center.

13. The method of claim 1, wherein executing the automatic following routine comprises:
a) verifying a communications link with the target vehicle;
b) communicating with the target vehicle to determine target vehicle operating parameters;
c) verifying the target vehicle operating parameters are each within a respective predetermined range; and,
d) providing output signals to control host vehicle forward speed and acceleration based upon the target vehicle operating parameters.

14. The method of claim 13, wherein providing output signals to control the host vehicle forward speed and acceleration based upon the target vehicle operating parameters comprises controlling at least one of an engine throttle position and host vehicle braking.

15. The method of claim 14, further comprising controlling a host vehicle transmission.

16. The method of claim 14, wherein host vehicle braking comprises engine braking.

17. The method of claim 13, wherein providing output signals to control host vehicle forward speed and acceleration based upon the target vehicle operating parameters comprises controlling magnitude of electrical energy delivered to a wheel motor.

18. The method of claim 13, wherein providing output signals to control host vehicle forward speed and acceleration based upon the target vehicle operating parameters comprises controlling magnitude of electrical energy delivered to an electric motor propulsion system.

19. The method of claim 1, further comprising: disengaging the automatic following routine upon interruption of communications between the host vehicle and the target vehicle.

20. The method of claim 1, further comprising: disengaging the automatic following routine upon detection of an intervening object.

21. The method of claim 1, further comprising: disengaging the automatic following routine upon an operator input.

22. Article of manufacture comprising:
a storage medium having a computer program encoded therein for effecting a method to control forward movement of a host vehicle, the host vehicle having an adaptive control system operable to control forward movement of the host vehicle and a localized communications system; the computer program comprising:
code for establishing communications with a target vehicle;
code for identifying the target vehicle to an operator of the host vehicle;
code for verifying an intent by the operator to follow the target vehicle; and,
code for executing an automatic following routine based upon target vehicle operating parameters and host vehicle and predetermined parameters for following.

23. The article of manufacture of claim 22 wherein the computer program further comprises code for determining the target vehicle operating parameters, said operating parameters comprising target vehicle heading, speed, acceleration and brake pedal input.

24. The article of manufacture of claim 23 wherein the computer program further comprises code for controlling input signals to an electronic throttle control device and a braking system based upon the determined target vehicle operating parameters.
